(19) United States
(12) Patent Application Publication
(10) Pub. No.: US 2013/0324201 A1
(43) Pub. Date: Dec. 5, 2013

(54) APPLYING GAMIFICATION TECHNIQUES TO PROCESS INCIDENTS

(71) Applicants: Peter Eberlein, Malsch (DE); Bare Said, St. Leon-Rot (DE)

(72) Inventors: Peter Eberlein, Malsch (DE); Bare Said, St. Leon-Rot (DE)

(21) Appl. No.: 13/486,791

(22) Filed: Jun. 1, 2012

(51) Int. Cl. G06F 17/00; G06F 9/46

(52) U.S. Cl. 463/7

(57) ABSTRACT

Methods, systems, and apparatus, including computer programs encoded on a computer storage medium for applying gamification techniques to process incidents. A gamification environment to process service incidents received at a service management computer system is developed based on skills of service incident processors who process service incidents and a respective level for each incident processor's skill. The gamification environment is provided to process service incidents received at the service management computer system from, for example, a customer organization. When a service incident is received, tasks to be performed to resolve the incident and one or more service incident processors who possess the skill at the level to perform the tasks are identified. The service incident is identified to the identified processors who resolve the incident. Once resolved, one or more of the identified incident processors are assigned a credit determined based on the service incident.

### TECHNICAL FIELD

The present disclosure relates to software, computer systems, and computer-implemented methods for processing incidents.

### BACKGROUND

A service management organization is receives service incidents describing issues faced by customers in a customer organization, and processes the incidents to resolve them to the satisfaction of the customers. An example of a service management organization is a computer help desk that receives computer- and software-related issues, for example, in electronic mails (e-mails), and resolves the issues, sometimes, by accessing the computer at issue. In some situations, the service management organization can implement a system in which service incidents received from a customer organization are arranged in a queue. A method by which the service management organization processes the service incidents can be based on an order in which the incidents are received from the customer. The team of personnel in the service management organization who process the incidents can be divided into multiple levels based on skill, expertise, and experience. Personnel at the lower levels can process and remove the simple incidents from the queue, and forward the comparatively more complex incidents to personnel at the higher levels. In this manner, the team of personnel works collectively to resolve the service incidents. If each member of the team selects a service incident that is easy for the member to resolve, then not only is the member not frequently challenged to improve his/her skills, expertise, and experience, but also the service provided to the customer can be negatively affected.

In one approach, the team of personnel of a service management organization who process and resolve service incidents is analogous to a party of characters in a role playing game. In the game, the party includes characters from various character classes with individual skills fighting opponents that collectively embark on adventures or campaigns. Each character performs one or more tasks so that the party can succeed in the adventure.

### SUMMARY

The present disclosure involves systems, software, and computer-implemented methods for applying gamification processes to process incidents.

In general, one innovative aspect of the subject matter described in this disclosure can be implemented as a non-transitory computer-readable medium storing computer program instructions executable by one or more data processing apparatus to perform operations. The operations include identifying, at a service incident management computer system, multiple values that correspond to multiple parameters based on which service incidents are to be processed, identifying, at the service management computer system, data describing multiple service incident processors to process the service incidents, and developing a gamification environment to process the service incidents. The developing includes determining, at the service management computer system, one or more skills of a respective service incident processor, and determining, at the service management computer system, a respective level for each of the one or more skills of the respective service incident processor. The operations include storing, at the service management computer system, the gamification environment that includes one or more skills for each of the multiple service incident processors, respective levels of skills for each of the one or more skills, the multiple parameters, and the multiple values in a computer-readable storage medium, and providing the gamification environment to process a service incident received at the service management computer system.

This, and other aspects, can include one or more of the following features. The multiple parameters can include at least one of a maximum time to process a service incident, a minimum time to process a service incident, or both. Developing the gamification environment can include identifying one or more service incident processors who can service at least a portion of a service incident within the maximum time and the minimum time. The multiple values can include at least one of a maximum value for the maximum time or a minimum value for the minimum time, or both. The data describing the multiple service incident processors can include a number of service incident processors, a skill and a level of the skill of each service incident processor. Developing the gamification environment can include identifying two or more service incident processors that share a common skill, arranging the two or more service incident processors in a hierarchy according to the common skill, and storing the hierarchy in the computer-readable storage medium. Providing the gamification environment to process the service incident can include receiving the service incident from a computer system over a network that connects the computer system and the service management system, identifying one or more skills and a level for each of the one or more skills needed to process the service incident while satisfying the multiple parameters, identifying one or more service incident processors that possess the one or more skills at the level for each of the one or more skills, and assigning the service incident to the identified one or more service incident processors. The operations can further include receiving a notification that the service incident has been processed, assigning a credit to each of the one or more service incident processors that depends on the one or more skills and the level for each of the one or more skills of each of the one or more service incident processors, and updating the gamification environment based on the assigned credit.

Another innovative aspect of the subject matter described here can be implemented as a computer-implemented method performed by one or more data processing apparatus to apply gamification techniques to process incidents. A service incident including multiple words that collectively describe an incident is received at a service incident management system that implements a gamification environment to process service incidents. From the multiple words, one or more skills and, for each of the one or more skills, a level of the one or more skills needed to process the service incident are identified. Using the gamification environment, multiple service incident processors are identified to perform the multiple tasks. Each of the service incident processors is associated with a respective skill and a respective level to perform at least one of the multiple tasks. The multiple tasks are assigned to the multiple service incident processors at the service management computer system.

This, and other aspects, can include one or more of the following features. Identifying the one or more skills needed to process the service incident can include accessing the gamification environment that stores multiple skills and multiple levels associated with the multiple service incident processors, and retrieves the one or more skills from the gamification environment. The gamification environment can include a computer-readable storage medium that stores multiple parameters based on which the service incident is to be processed. Identifying the multiple service incident processors can further include identifying the multiple service incident processors who can process the service incident to satisfy the multiple parameters. The multiple parameters can include a minimum time to process the service incident and a maximum time to process the service incident. Identifying the multiple service incident processors can include identifying the multiple service incident processors who can collectively process the service incident within the minimum time and the maximum time. The service incident can include one or more items of data. Identifying the one or more skills and, for each of the one or more skills, the level of the one or more skills, can include identifying the one or more skills based on the multiple words and the one or more items of data. A notification can be received that the service incident has been processed. A credit can be assigned to each of the multiple service incident processors. The credit can be based on operations performed by each of the multiple service incident processors to process the service incident. The gamification environment can be updated based on the assigned credit. A value for resolving the service incident can be determined, and distributed among each of the multiple service incident processors based on a distribution that represents contributions by the multiple service incident processors to resolving the service incident.

A further innovative aspect of the subject matter described here can be implemented as a system that includes one or more data processing apparatus, and a computer-readable storage medium storing computer program instructions executable by data processing apparatus to perform one or more of the operations described in this disclosure.

While generally described as computer-implemented software embodied on tangible media that processes and transforms the respective data, some or all of the aspects may be computer-implemented methods or further included in respective systems or other devices for performing this described functionality. The details of these and other aspects and implementations of the present disclosure are set forth in the accompanying drawings and the description below. Other features and advantages of the disclosure will be apparent from the description and drawings, and from the claims.

### BRIEF DESCRIPTION OF THE DRAWINGS

FIG. 1 illustrates an example of a service management system that implements gamification to process service incidents.

FIG. 2 illustrates a conceptual transfer of a gamification environment to a service incident management system.

FIG. 3 illustrates example components of the gamification environment implemented by the service management system.

FIG. 4 is a flowchart including swim lanes to provide a service incident management system to process service incidents.

FIG. 5 is a flowchart including swim lanes describing processing a service incident.

FIG. 6 illustrates an example of a user interface that displays information describing an incident processor.

Like reference numbers and designations in the various drawings indicate like elements.

### DETAILED DESCRIPTION

This disclosure describes computer-implemented methods, computer-readable media, and computer systems for implementing gamification in computer systems that perform service management. Service management, in some implementations, can include processes implemented by an organization to resolve issues—sometimes knows as service incidents—presented by a customer organization. The service management organization, which can be a division of the customer organization or a separate organization, can include a team of service personnel (referred to below as service incident processors) that collectively possess the skills, expertise, and experience to resolve the service incidents presented by the customer organization.

When the service management organization receives a service incident, the organization can identify one or more members of the team who can resolve the incident. The organization can assign the service incident to the identified members who work on and resolve the incident. To do so, a first of the identified members can work on the service incident followed by a second of the identified members, and so on, until the service incident has been resolved. The service management organization can then notify the customer organization that the service incident has been resolved. In some situations, the service management organization can solicit and receive feedback from the customer organization regarding the quality of service. Responsively, the service management organization can review and update its service management processes as needed.

In some situations, the service management organization may request the customer to provide additional information describing the incident. In such situations, the customer may need to do more than simply submit the service incident. In some situations, a service incident may not have been resolved despite the service management organization's notification to the customer organization that it has. In such situations, the customer organization may return the incident to the service organization necessitating at least one additional iteration of processing to resolve the incident.

For example, the service management organization can be an Information Technology (IT) help desk that receives computer- and software-related service incidents from employees of the customer organization, and resolves the incidents. A service incident can be a description of a computer-related problem. In some implementations, the IT help desk can provide a user interface—for example, a web page of a website—in which a member of the customer organization can describe, for example, in words, the issue that needs to be resolved. In the user interface, the IT help desk can additionally include functionality to upload data, for example, files, that are associated with the service incident. In this manner, the customer organization can route service incidents to the IT help desk. The IT help desk can include a team of several members that have skills ranging from basic troubleshooting skills to core software development skills, experiences ranging from a few months to several years in the IT field, and a range of expertise. The areas of expertise can include, for example, databases, operating systems, workflow systems, business applications (such as, financial, human resources, supply chain management, customer relationship management, supplier relationship management, project management), and process integration, to list a few. When the IT help desk receives a service incident, the help desk assigns the incident to one or more members who work on and resolve the incident. The IT help desk then notifies the customer organization that the service incident has been resolved, and subsequently solicits feedback from the customer organization about the quality of service.

One goal of the service management organization is to maximize the satisfaction of the customer organization while minimizing its own costs. This goal can be achieved, for example, by generating a queue of multiple service incidents and processing the incidents in the queue in an order in which the incidents were received. The goal of maximizing customer satisfaction while minimizing costs can also be achieved by processing service incidents as quickly as possible to minimize the number of service incidents in the queue. However, some later-received service incidents may need to be allocated a higher priority relative to earlier-received service incidents depending, for example, on complexity of the later-received incidents, a source from which the later-received incident is received, service level agreements between the customer organization and the service management organization, and the like. Moreover, these goals can be undermined by providing standard solutions or asking customers who provide service incidents for additional information in an effort to quickly resolve an incident and dispose it from the queue.

This disclosure describes implementing gamification in service management to achieve some of the goals of the service management organization to leverage the similarities between service management and gamification. Role-playing game (RPG) is one form of gamification in which players assume the roles of characters in a fictional setting. Players take responsibility for acting out roles within a narrative, for example, through a process of structured decision-making or character development. Actions taken within the game succeed or fail according to a system of rules and guidelines. In an RPG, for example, several participants from various character classes, each having individual skills in fighting opponents, form a party that undertakes an adventure. Each participant gathers experience points that advance the participant's respective level if the character succeeds. One strategy when playing such an RPG is to select adventures that promise high reward but are manageable by matching the skills of each participant in the party to those of the opponents in the adventure.

The strategy implemented by a team of personnel to manage service incidents can be analogized to that implemented by the party playing an RPG. For example, the team of personnel need to “fight down” service incidents of different complexity with the right priority. By implementing gamification in service management, each team member can be matched with a task that the team member can efficiently resolve. In addition, the implementation can also identify an order in which service incidents can be processed, for example, based on service level agreements, priorities, and the like.

Once a service incident has been resolved, each team member who resolved a task associated with the service incident can receive credit for having done so. For example, depending on a team member's contribution to resolve the service incident, the team member's skill level, expertise level, experience level, or combinations of them, can be modified and the modified level can be stored. When a new service incident is received, it can be determined that the team member's modified skill/experience/expertise level qualifies the team member to perform a task associated with the new service incident. Responsively, the team member can be assigned the task. In this manner, team members can regularly be challenged to acquire new skills by being assigned new tasks. The team members can demonstrate the acquisition of new skills and expertise by successfully performing the new tasks. The team members can be rewarded with newer, yet performable tasks, associated with future service incidents.

Implementing gamification in service management can offer one or more of the following potential advantages. Implementing game-like mechanics in a business process can yield an improvement in one or more of the business process, a customer experience, profits of the service organization, or combinations of them. The team members working in incident and service management can be supported with a rule-based pre-filtering of service incidents that match to the team members' skills and competencies. This can allow team members to organize their work on their own authority. In addition, attention can be directed to high-priority service incidents to increase compliance with service agreements between the service management organization and the customer organization. These, in turn, can increase a quality of service incident processing, and additionally motivate and engage team members.

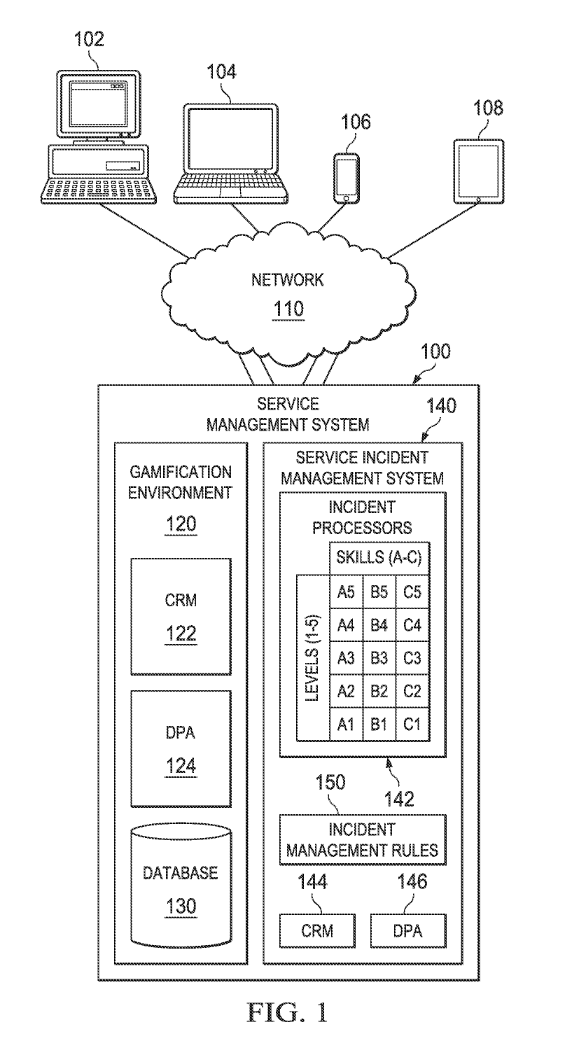

FIG. 1 illustrates an example of a service management system 100 that implements gamification to process service incidents. The service management system 100, which can be implemented as a computer system, can be connected to multiple client devices—for example, a first client device 102, a second client device 104, a third client device 106, a fourth client device 108, and the like—through one or more wired or wireless networks 110 such as the Internet. A client device can include any computer system, for example, a desktop computer, a laptop computer, a personal digital assistant, a tablet computer, a smart phone, and the like. The client devices can be computer systems used by a customer organization, for example, by employees of the customer organization. As described below, the service management system 100 can implement a gamification environment to process service incidents received at the service management system 100 from one or more of the client devices through the networks 110.

The service management system 100 can store information describing a gamification environment 120. For example, the gamification environment 120 can store multiple rules and guidelines—for example, as computer-readable instructions—for implementing gamification, for example, in a database 130. The gamification environment 120 can include a computer-readable medium 122 to store the computer-readable program instructions executable by data processing apparatus 124 to create a service incident management system 140 that is analogous to the gamification environment 120.

The service incident management system 140 can include information describing a team of service incident processors, for example, people who receive, process, and resolve service incidents. The management system 140 can include service incident management rules 150—for example, computer-readable instructions—for processing service incidents. For example, the service incident management rules 150 can be stored on a computer-readable medium 144 executable by data processing apparatus 146.

In some implementations, the service incident management system 140 can store the information describing the team of service incident processors 142 in a format, for example, a table, in which the processors are arranged hierarchically according to skills and levels of the processors. A service incident processor 142 who has several skills and a high level of expertise/experience in each skill can be at a top of the table while a service incident processor 142 who has fewer skills and is a beginner at each skill can be at a bottom of the table. Each service incident processor's position in the table can vary as the processor processes service incidents. For example, successful completions of tasks associated with a service incident in accordance with the incident management rules 150 can result in an increase in the processor's skill or level (or both). Conversely, repeated failure to complete tasks can result in a decrease in the skill or level (or both).

In some implementations, the service management system 100 can develop a gamification environment to process the service incidents. To do so, the service management system 100 and the customer organization can establish service level agreements based on which the service management system 100 can process service incidents. In the service level agreements, the customer organization can specify multiple parameters based on which the customer organization wants service incidents processed. Examples of parameters can include a maximum time processing time (MPT) for an incident, a minimum initial response time (IRT) to respond to a received incident (or both). The values of these parameters can be conditional depending on the severity of the issues described in the service incident. For example, if the customer experiences a complete system outage, then the IRT and MPT can be lower than the IRT and MPT when the customer experiences a glitch in a user interface. In some situations, the customer organization and service management organization can agree upon indicators of severity, for example, “very high priority.” Further, even if the customer organization used an incorrect indicator when submitting a service incident, the service management organization may alter the indicator based on the actual severity of the issues.

To develop the gamification environment, the service management system 100 can identify one or more service incident processors 142 who can service at least a portion of a service incident in accordance with the values of the multiple parameters specified by the customer organization. For example, based on a skill of each incident processor 142 and a level of the skill of each incident processor 142 (which is stored by the service incident management system 140), the service management system 100 can identify one or more service incident processors 142 who can service tasks associated with the service incident within the maximum and minimum times specified by the customer organization.

In this manner, the service incident management system 140 can store incident processors 142 and incident management rules 150 which the service management system 100 develops based on the rules specified in the gamification environment 120. The service management system 100 can provide the gamification environment to process service incidents received at the service management system 100 from the client devices through the networks 110. A conceptual transfer of the gamification environment 120 to a service incident management system 100 is described with reference to FIG. 2.

FIG. 2 illustrates a conceptual transfer of a gamification environment to a service incident management system. The management system 100 includes a service incident management team, which is the equivalent of game masters in a gamification environment. Game masters establish the game rules that must be satisfied, for example, for a team to successfully complete a level and advance to another level. For example, the game masters can specify key performance indices (KPIs) that must be achieved in a game. Analogously, the service incident management team establishes rules and parameters within which service incidents must be resolved. For example, the parameters can include a maximum time and a minimum time to resolve a service incident as described above, an initial reaction time to respond to an incident, and the like. The management team can establish these rules based, in part, on service level agreements with the customer organization.

The gamification environment is defined by an organizational structure. Support employees (player characters) are grouped in teams (parties) with diverse profiles (character classes). These parties can be assigned to specific support components known in the gamification environment as campaigns. Similarly, service incident processors are a team of individuals, each of whom has a specific job profile requiring that individual to resolve at least one task associated with a service incident. Like stats/levels associated with player characters, service incident processors are associated with skills and competencies, and job grades. Just as a player character's stats/levels reflect a player's abilities in an RPG, a service incident processor's skills, competencies, and job grades also reflect the processor's abilities to resolve service incidents in accordance with the service level agreements.

The service incident management system 100 is configured to map the steps of the gamification environment to business processes of service incident management. As a campaign in a gamification environment is a starting point in a story that unfolds as a choice of appropriate adventures offered to the characters, a queue of service incidents is assigned to a team of service incident processors who identify incidents in the queue to resolve based on their skills, levels, and expected reward. To implement this gamification principle to an analogous business process, the service incident management system 100 stores statistics that express the skills, levels, and competencies of the service incident processors, as described above with reference to FIG. 1. The management system 100 obtains initial values for the incident processors from multiple sources, for example, the human resources department that stores each incident processor's resume, from the incident processor herself, and the like.

As an incident processor resolves incidents, her statistics are updated with the experience, skill, level, and expertise gained by doing so. The management system 100 can automatically update the incident processor's statistics based on the updates or, alternatively, can allow the incident processor to do so herself. In some implementations, the management system 100 can modify the updates applied by the incident processor or vice versa. Based on a difficulty and complexity of a service incident that the incident processor resolves, the management system 100 allocates experience points to the incident processor.

In some implementations, the management system 100 can allocate experience points for each task associated with a service incident that the incident processor successfully performs. Alternatively, or in addition, the management system 100 can allocate points to a successfully completed service incident. The points can depend on several factors including, for example, the support level that the incident has reached (i.e., the higher the skill level of the incident processor handling the service incident, the greater the support level), time factors (for example, a total time since the incident was obtained, total processing time on each level, and the like), and the number of incident processors who handle the service incident. The service management system 100 can distribute the points allocated to the service incident among the one or more service incident processors that processed the service incident, for example, as experience points.

In some implementations, the service management system 100 can assign experience points to a user based, in part, on a customer's rating of an incident processor's performance. For example, if a customer provided a five star rating for a resolution provided by a particular incident processor, the service management system 100 can provide experience points proportional to the rating. In another example, the service management system 100 can allocate experience points based on reviews of the incident processor either by peers or superiors (or both). The service management system 100 can alternatively, or in addition, assign the experience points based on the novelty of the service incident that an incident processor resolved. For example, if the service incident described a known and previously resolved issue—particularly, one that the incident processor has previously resolved—then, the service management system 100 can assign lesser experience points. Relatively, the service management system 100 can assign more experience points if the service incident describes a new issue—particularly, one that the incident processor has not previously handled.

Once the incident processor has accumulated sufficient experience points, the incident processor's skill or level (or both) advance, causing in a movement of the incident processor in the incident processors 142 table described above with reference to FIG. 1. The processor gains experience and receives credit based on the rating of the incident (i.e., more difficult the resolved incident, greater the credit). The service management system 100 can provide awards to successful incident processors for their work in the form of real or virtual badges or trophies or in bonus compensation depending upon company policy. For example, the service management system 100 can offer an award to an incident processor who closes a service incident that is approaching or has exceeded maximum processing times specified in the service level agreements. Another award may be granted for solving service incidents received from important customers, for example, a President of the customer organization, or for resolving a service incident associated with a new product.

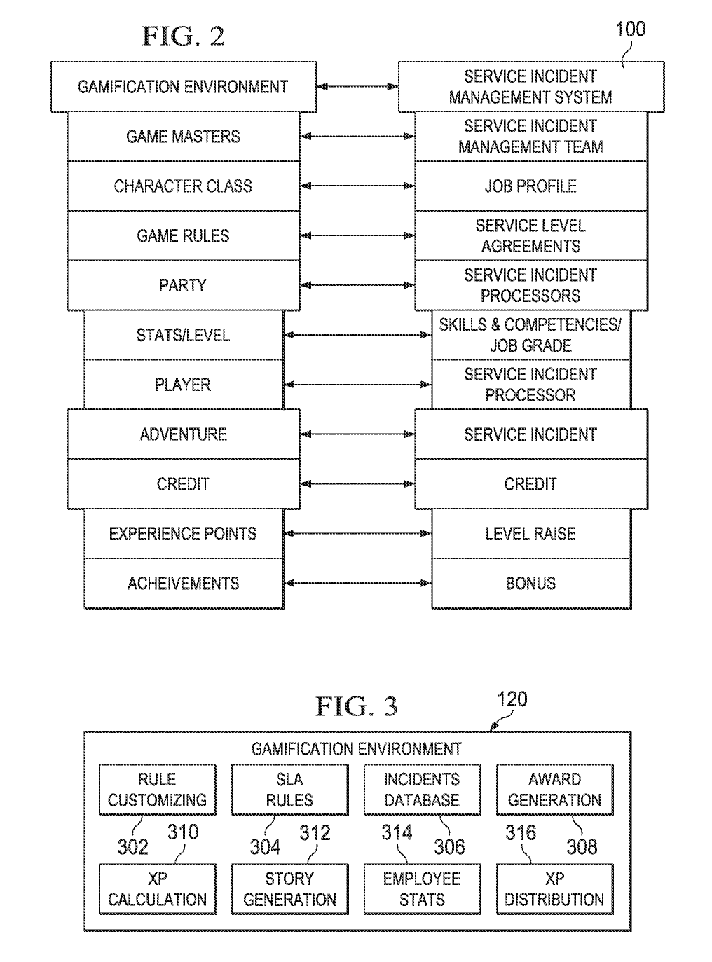

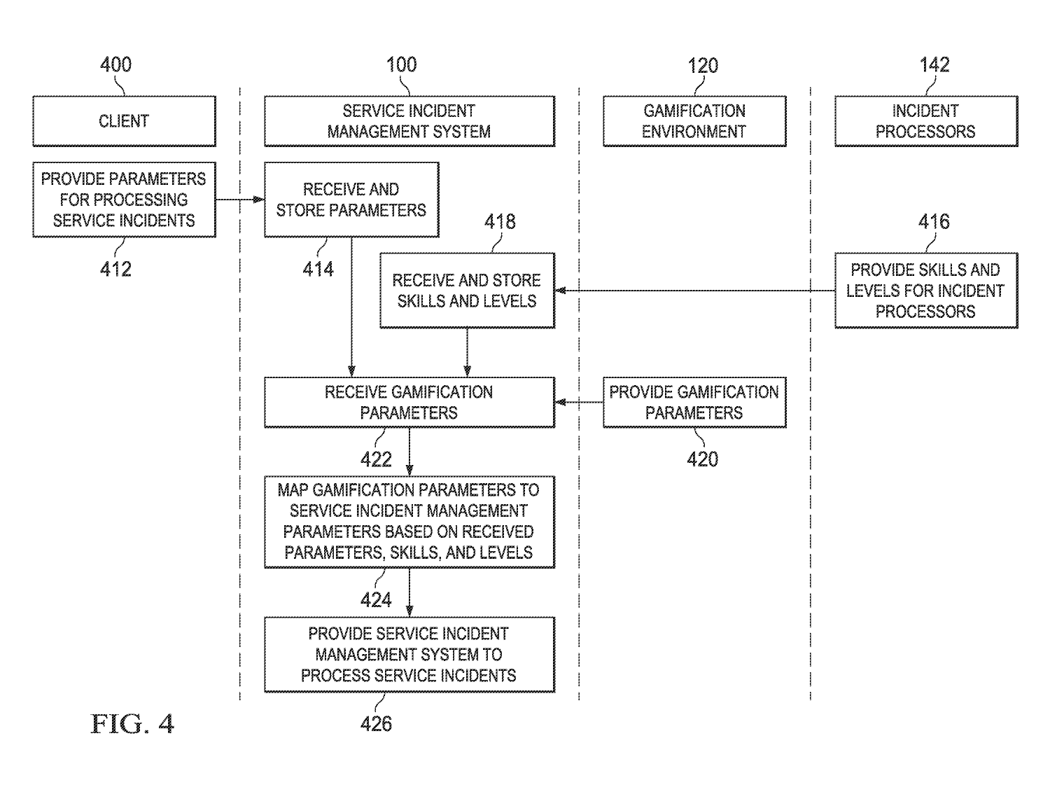

FIG. 3 illustrates example components of the gamification environment 120 implemented by the service management system 100. In Rule Customizing 302, the SLA Rules 304 are defined that determine which service incidents from the Incidents Database 306 result in an award when resolved. These rules are evaluated by the Award Generation component 308 that creates awards and associates them with incidents in the Incidents Database 306 in a prominent way (for example, using badges, trophies, and the like). The SLA Rules 304 are also input to the Experience Points (XP) Calculation engine 310 that recalculates the total experience points that can be gained by participating in the solution of incidents in the Incidents Database 306. Input parameters can include the support component, support level, which can be derived from a frequency with which the service incident was forwarded down the support chain, total processing time (relative to maximum processing time defined in the SLAs), initial reaction time to commence processing the service incident, total time since incident was crated, number of incident processors, number of customer queries, and the like. The Story Generation component 312 can match incident levels stored in the Incidents Database 306 with Employee Stats 314 to identify open service incidents and the service incident processors who are best qualified to resolve them. Once a service incident has been resolved, the contribution of each incident processor who participated in processing the incident is evaluated in the XP Distribution component 316. Incident processors can receive experience points based on a distribution across their respective skills, which, in turn, can result in one or more incident processors advancing in their respective levels. Once the gamification of the business processes has been completed, the service management system 100 can implement the optimized service management processes as described below with reference to FIG. 4.

FIG. 4 is a flowchart including swim lanes to provide a service incident management system to process service incidents. Initially, the client 400 (for example, the customer organization) and the service incident management system 100 identify parameters for processing service incidents. At 412, the client 400 can provide parameters (for example, values for initial reaction time, maximum response time, and the like) to the service incident management system 100. At 414, the service incident management system 100 can receive and store the parameters, specifically, the values of the parameters. At 416, incident processors 142 can provide skills and levels describing themselves to the service incident management system 100. As described above, the skills and levels of the service incident processors 142 can be alternatively or additionally received from other sources, for example, the human resources department. The service incident management system 100 can receive and store the skills and levels at 418.

Based on the skills and levels, the service incident management system 100 can develop a hierarchy of service incident processors distributed across multiple levels. A first level (for example, an entry level) of service incident processors can include members with the least skills or experience or both. For example, the members of the first level may be the ones who are initially exposed to the client 400, and who receive a service incident—over the networks 110 or over the phone—from the client 400. The tasks performed by these members can be simple, such as, looking up a database of solutions to past queries to determine if a solution to a service incident has previously been documented, and, if yes, then providing the solution to the client 400. A second level can include members who have more skill or experience or both relative to members of the first level. If a first level member is unable to find a solution to a service incident received from the client 400, then the first level member can forward the incident to the second level. A highest level can include members with the most skill, expertise, and experience. In the context of an IT help desk, the highest level can include members who wrote the computer software application to which the service incident is related. The highest level members may not be exposed to all service incidents, but instead, only to those incidents that are unresolvable by the other levels.

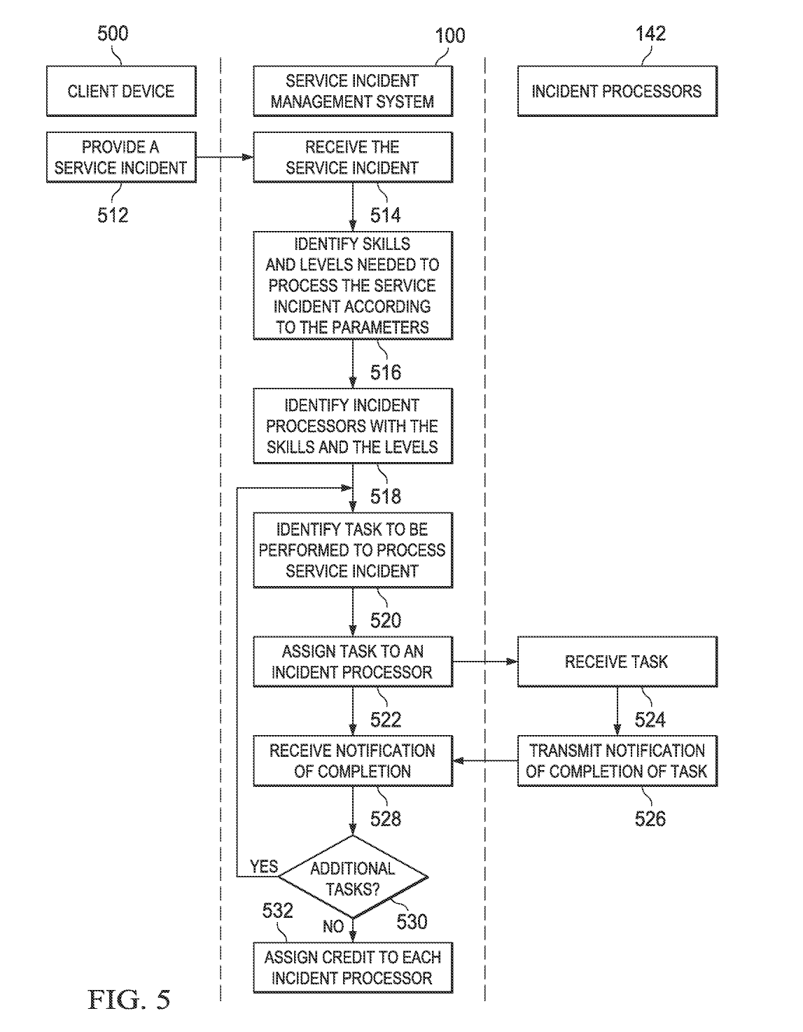

The gamification environment 120 provides the gamification parameters at 420. At 422, the service incident management system receives the gamification parameters, and, at 424, maps the gamification parameters to the service incident management parameters based on received parameters, and skills and levels included in the hierarchy of service incident processors described above. Mapping the gamification environment can include developing the gamification environment by identifying service incident processors that share a common skill, and arranging the incident processors in a hierarchy, as described above, according to the common skill. In some implementations, the hierarchy can be stored in a computer-readable storage medium that can be accessed by the data processing apparatus of the service incident management system 100. At 426, the service incident management system is provided, for example, to the client 400, to resolve service incidents. An example of resolving a service incident is described with reference to FIG. 5.

FIG. 5 is a flowchart including swim lanes describing processing a service incident. At 512, a client device 500 provides a service incident. For example, a user of the client device 500 describes, in words, the issues faced by the user. At 514, the service incident management system 100 receives the service incident. For example, the management system 100 receives the textual description of the issue, and, in some situations, data files associated with the issue. At 516, the management system 100 identifies skills and levels needed to process the service incident according to the parameters. For example, the management system 100 can identify the skills and levels based on the words describing the issue. Then, at 518, the management system 100 can then identify incident processors who possess the skills and are at the levels determined to resolve the service incident. In some implementations, the first level of the hierarchy of service incident processors described above receive the service incident by default, and determine whether to attempt to resolve the incident or to forward the incident to a higher level in the hierarchy. In some implementations, based on words provided by the client device 500, the management system 100 can identify a level of the hierarchy to which the service incident is to be routed.

At 520, the management system 100 can identify a task, which is associated with the service incident, to be processed by an identified incident processor. At 524, the management system 522 can assign the task to the identified incident processor. An incident processor 142 can receive the assignment at 524, perform the task, and transmit notification of completion of the task to the management system at 526. At 528, the management system 100 can receive the notification of completion, and, at 530, can determine if additional tasks need to be performed to resolve the service incident. If the management system 100 determines that an additional task needs to be performed (decision branch “YES”), then the management system 100 can repeat processes 520, 522, 528. If the management system 100 determines that no additional tasks need be performed (decision branch “NO”), then, the management system 100 can notify the client device 500 that the issue has been resolved. Further, at 532, the management system 100 can assign credit for resolving the service incident to each incident processor.

To assign credit for resolving a service incident, the management system 100 can perform an experience point calculation to determine a value to be assigned for resolving the service incident. This value can depend on factors including how valuable resolving the incident is to the customer organization, the complexity of the issue described in the incident, urgency to resolve the issues, and the like. Some of the factors can be specified in the parameters provided in the service level agreements. Additional factors can be specified when the service incident is received. For example, in the text describing the issue, the user of the client device 500 can explicitly state that the service incident needs to be resolved as soon as possible. Further, factors can also be received from the client after the service incident has been resolved, for example, in the form of customer feedback. Furthermore, factors can be received from incident processors themselves. For example, an incident processor can specify her contribution to the resolution and also describe any skill, such as a new skill, that the processor used to perform the task assigned to her. Moreover, the value can depend on a number of incident processors that resolved the incident and on whether advanced support levels were involved in processing the incident. In the example of an IT help desk, if the service incident was caused by a bug in the computer software, then a developer (an advanced support level team member) may resolved the service incident. Such a service incident can be more valuable relative to one which a lower support level team member resolved.

From the experience point determined for resolving the service incident, the management system 100 can determine an experience distribution to distribute a portion of the experience point to each incident processor who worked to resolve the incident. The portion of the experience point allocated to an incident processor can depend, for example, on the contribution of the incident processor to the resolution of the incident. In some implementations, the experience point can be equally apportioned to each incident processor. In some implementations, the experience point can be distributed according to rules and parameters that accounts for each incident processor's contribution to the resolution of the incident. For example, the customer who provided the service incident and members of the team of service personnel can be asked for significant steps that were taken to resolve the incident. Based on the feedback, the significant steps can be identified. Then, a service incident processor who performed the significant step can be identified. A fraction of the experience point can be allocated to the identified processor.

In some situations, the experience point can be distributed equally among the service incident processors who performed the significant steps. Alternatively, or in addition, the significant steps can be ranked according to degrees of significance, and the experience point can be distributed based on the degrees. Further, if the same service incident processor performed more than one of the significant steps, then the fraction allocated to each significant step can be allocated to that incident processor. Upon determining the experience point distribution, the management system 100 can allocate the determined credit to each incident processor, and update each incident processor's position in the hierarchy of incident processors as applicable.

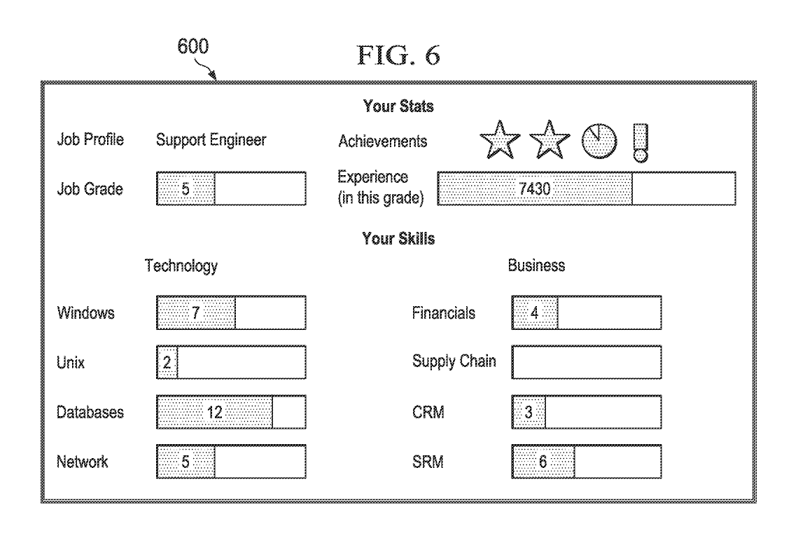

Each incident processor can be associated with a user interface, such as the example user interface shown in FIG. 6, in which information describing the incident processor and the incident processor's skills, levels, achievements, and credit received for resolving service incidents is displayed. Through the user interface, each incident processor can gain information about her respective position in the hierarchy of incident processors. In this disclosure, examples of service management are described with reference to an IT help desk. In general, the service management system 100 that implements a gamification environment can be implemented by any service management organization in which a team of personnel receive, process, and resolve any types of service incidents received from a customer organization. Globally, the techniques described here can be implemented in any scenario, for example, any professional services industry, in which service requests are processed by a team of professional services employees that provide that service to a customer. Consulting service is one such example.

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices). The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices.

Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method performed by one or more data processing apparatus to apply gamification techniques to process incidents, the method comprising:
receiving, at a service management computer system that implements a gamification environment to process service incidents, a service incident including a plurality of words that collectively describe an incident;
identifying from the plurality of words, one or more skills and, for each of the one or more skills, a level of the one or more skills needed to process the service incident;
determining, from the service incident, a plurality of tasks to be performed to resolve the service incident, wherein each task is associated with a skill and a level;
identifying, using the gamification environment, a plurality of service incident processors to perform the plurality of tasks, wherein each of the service incident processors is associated with a respective skill and a respective level to perform at least one of the plurality of tasks; and
assigning, at the service management computer system, the plurality of tasks to the plurality of service incident processors.

2. The method of claim 1, wherein identifying the one or more skills needed to process the service incident comprises:
accessing the gamification environment that stores a plurality of skills and a plurality of levels associated with the plurality of service incident processors; and
retrieving the one or more skills from the gamification environment.

3. The method of claim 2, wherein the gamification environment includes a computer-readable storage medium that stores a plurality of parameters based on which the service incident is to be processed, and wherein identifying the plurality of service incident processors further comprises identifying the plurality of service incident processors who can process the service incident to satisfy the plurality of parameters.

4. The method of claim 3, wherein the plurality of parameters includes a minimum time to process the service incident and a maximum time to process the service incident, and wherein identifying the plurality of service incident processors comprises identifying the plurality of service incident processors who can collectively process the service incident within the minimum time and the maximum time.

5. The method of claim 1, wherein the service incident includes one or more items of data, and wherein identifying the one or more skills and, for each of the one or more skills, the level of the one or more skills comprises identifying the one or more skills based on the plurality of words and the one or more items of data.

6. The method of claim 1, further comprising:
receiving a notification that the service incident has been processed;
assigning a credit to each of the plurality of service incident processors that is based on operations performed by each of the plurality of service incident processors to process the service incident; and
updating the gamification environment based on the assigned credit.

7. The method of claim 6, wherein assigning the credit to each of the plurality of service incident processors comprises:
determining a value for resolving the service incident; and
distributing the value among each of the plurality of service incident processors based on a distribution that represents contributions by the plurality of service incident processors to resolving the service incident.

8. A non-transitory computer-readable medium storing computer program instructions executable by one or more data processing apparatus to perform operations comprising:
identifying, at a service management computer system, a plurality of values that correspond to a plurality of parameters based on which service incidents are to be processed;
identifying, at the service management computer system, data describing a plurality of service incident processors to process the service incidents;
developing a gamification environment to process the service incidents, wherein the developing comprises:
from the data describing the plurality of service incident processors and for each service incident processor:
determining, at the service management computer system, one or more skills of a respective service incident processor, and
determining, at the service management computer system, a respective level for each of the one or more skills of the respective service incident processor;
storing, at the service management computer system, the gamification environment that includes one or more skills for each of the plurality of service incident processors, respective levels of skills for each of the one or more skills, the plurality of parameters, and the plurality of values in a computer-readable storage medium; and
providing the gamification environment to process a service incident received at the service management computer system.

9. The medium of claim 8, wherein the plurality of parameters includes at least one of a maximum time to process a service incident, a minimum time to process a service incident, or both, and wherein developing the gamification environment comprises identifying one or more service incident processors who can service at least a portion of a service incident within the maximum time and the minimum time.

10. The medium of claim 9, wherein the plurality of values includes at least one of a maximum value for the maximum time or a minimum value for the minimum time, or both.

11. The medium of claim 8, wherein the data describing the plurality of service incident processors includes a number of service incident processors, a skill and a level of the skill of each service incident processor.

12. The medium of claim 11, wherein developing the gamification environment comprises:
identifying two or more service incident processors that share a common skill;
arranging the two or more service incident processors in a hierarchy according to the common skill; and
storing the hierarchy in the computer-readable storage medium.

13. The medium of claim 8, wherein providing the gamification environment to process the service incident comprises:
receiving the service incident from a computer system over a network that connects the computer system and the service management system;
identifying one or more skills and a level for each of the one or more skills needed to process the service incident while satisfying the plurality of parameters;
identifying one or more service incident processors that possess the one or more skills at the level for each of the one or more skills; and
assigning the service incident to the identified one or more service incident processors.

14. The medium of claim 13, wherein the operations further comprise:
receiving a notification that the service incident has been processed;
assigning a credit to each of the one or more service incident processors that depends on the one or more skills and the level for each of the one or more skills of each of the one or more service incident processors; and
updating the gamification environment based on the assigned credit.

15. A system to apply gamification techniques to process incidents, the system comprising:
one or more data processing apparatus; and
a computer-readable storage medium storing computer program instructions executable by data processing apparatus to perform operations comprising:
receiving a service incident including a plurality of words that collectively describe an incident;
identifying from the plurality of words, one or more skills and, for each of the one or more skills, a level of the one or more skills needed to process the service incident;
determining, from the service incident, a plurality of tasks to be performed to resolve the service incident, wherein each task is associated with a skill and a level;
identifying, using the gamification environment, a plurality of service incident processors to perform the plurality of tasks, wherein each of the service incident processors is associated with a respective skill and a respective level to perform at least one of the plurality of tasks; and
assigning the plurality of tasks to the plurality of service incident processors.

16. The system of claim 15, wherein identifying the one or more skills needed to process the service incident comprises:
accessing the gamification environment that stores a plurality of skills and a plurality of levels associated with the plurality of service incident processors; and
retrieving the one or more skills from the gamification environment.

17. The system of claim 16, wherein the gamification environment includes a computer-readable storage medium that stores a plurality of parameters based on which the service incident is to be processed, and wherein identifying the plurality of service incident processors further comprises identifying the plurality of service incident processors who can process the service incident to satisfy the plurality of parameters.

18. The system of claim 17, wherein the plurality of parameters includes a minimum time to process the service incident and a maximum time to process the service incident, and wherein identifying the plurality of service incident processors comprises identifying the plurality of service incident processors who can collectively process the service incident within the minimum time and the maximum time.

19. The system of claim 15, wherein the service incident includes one or more items of data, and wherein identifying the one or more skills and, for each of the one or more skills, the level of the one or more skills comprises identifying the one or more skills based on the plurality of words and the one or more items of data.

20. The system of claim 15, the operations further comprising:
receiving a notification that the service incident has been processed;
assigning a credit to each of the plurality of service incident processors that is based on operations performed by each of the plurality of service incident processors to process the service incident; and
updating the gamification environment based on the assigned credit.
